(19) United States
(12) Patent Application Publication
(10) Pub. No.: US 2017/0356298 A1
(43) Pub. Date: Dec. 14, 2017

(54) STATOR VANE

(71) Applicant: ROLLS-ROYCE PLC, London (GB)

(72) Inventor: Elliot CARTY, Derby (GB)

(73) Assignee: ROLLS-ROYCE PLC, London (GB)

(21) Appl. No.: 15/598,602

(22) Filed: May 18, 2017

(30) Foreign Application Priority Data
Jun. 8, 2016 (GB) 1610004.2

(51) Int. Cl. F01D 9/04

(52) U.S. Cl. CPC F01D 9/041; F01D 9/042; F05D 2220/32; F05D 2300/10; F05D 2230/21

(57) ABSTRACT

A stator vane for a gas turbine engine is provided. The stator vane has a platform surface from which an aerofoil extends, and a joggle surface that is circumferentially and radially displaced from the platform surface. Multiple stator vanes are arranged together to form a stator vane row, with each stator vane in the row remaining independent of the others. When the stator vanes are assembled together in a row, the joggle surface of one vane circumferentially overlaps a recess surface formed in a neighbouring vane. Because of the increased circumferential extent of the vanes, the vane is able to rotate in a retaining slot less than a conventional vane. This results in less wear and/or damage to the components.

### CROSS-REFERENCE TO RELATED APPLICATIONS

This specification is based upon and claims the benefit of priority from UK Patent Application Number 1610004.2 filed on 8 Jun. 2016, the entire contents of which are incorporated herein by reference.

### BACKGROUND

### 1. Field of the Disclosure

The present disclosure relates to a stator vane for a gas turbine engine, a stator vane stage, and a gas turbine engine.

### 2. Description of the Related Art

An axial compressor of a gas turbine engine comprises one or more rotor assemblies which carry rotor blades of aerofoil cross-section. The rotor is located by bearings, which are supported by a casing structure. The casing includes stator vanes, also of aerofoil cross-section. Each rotor and its downstream stator row form a stage.

Such vanes can be secured into the casing using a dovetail or T-slot fixing. FIG. 1 shows schematically the fixing parts of two adjacent vanes 1 of a stator vane row. Each vane has an aerofoil 2 and a fixing portion 3 from which the body extends into the working gas passage of the engine. Front 4 and rear 5 tangs of the platform are for use in a T-slot fixing slot 8 (see FIG. 2) within the casing.

In operation, aerodynamic loading on the aerofoil body induces a torque T (as illustrated in FIG. 2) that tends to rotate the vane around the radial direction of the engine. Under this rotation, neighbouring lateral edges 6 (which may extend substantially axially in the engine) of adjacent platforms slide along each other until interference at reaction points 7 of the front 4 and rear 5 tangs with the casing slot 8 limits the rotation by reacting the torque, as shown schematically in FIG. 2(a).

The casing slot 8 may be provided with a so-called anti-fret liner, for example around the face where the contact points 7 occur. However, excessive rotation of the metallic vanes 1 before contact 7 with such an anti-fret liner occurs may result in high contact loads, which may lead to excessive wear of the ant-fret liner and/or break-up of the anti-fret liner, which may cause material to be released. Such material release may cause damage to downstream parts of the engine, as well as to the anti-fret liner itself.

To limit the rotation, and thus try to reduce the damage to the casing and/or anti-fret liner, adjacent metallic vanes may be permanently joined (e.g. welded or brazed together) by a secondary manufacturing process at neighbouring lateral edges. As shown schematically in FIG. 2(b), for a given vane-to-casing axial clearance A, the greater circumferential width W2 of joined vanes substantially reduces the amount of rotation before contact 7 with the casing compared with that of the circumferential width W1 of the individual vanes.

However such secondary manufacturing increases the cost of the vanes, not just because of the secondary process itself, but also because of the need to inspect the joint (e.g. using X-rays and/or penetrant dye for example) post-manufacture. In addition, secondary manufacturing processes such as welding and brazing can induce distortions of the platforms 3, producing a mismatch between platforms that introduces local disturbances in the airflow and corresponding small performance losses within the stage.

A further disadvantage of permanently joining adjacent vanes is that it reduces the amount of frictional damping between vanes in a given vane row, thereby increasing vane amplitude/deflection for vibration modes that may be excited via upstream/downstream forcing.

It would be desirable to produce an improved stator vane, for example one which addresses at least one of the problems described above and/or facilitates a range of manufacturing methods, such as metal injection moulding (MIM).

### SUMMARY

According to an aspect, there is provided an annular stator vane row as provided in claim 1.

Such an arrangement may result in reduced angular rotation of the vanes before contact is made between the vane (for example the fixing portion thereof) and the casing/retaining slot (for example with an ant-fret liner), but without the disadvantages associated with joining vanes together to form multiple vane assemblies (such as that shown by way of example in FIG. 2(b)). This may alleviate and/or substantially eliminate at least one of the problems with conventional single metallic vanes and multiple metallic vane assemblies discussed above and elsewhere herein. The increased circumferential extent of the stator vane resulting from the combination of the platform surface and the joggle surface may be responsible for the decreased angular rotation before contact with the casing/retaining slot, compared with a conventional stator vane.

The metallic vane may be said to be entirely metallic, for example it may comprise only metal. The metallic vane may be homogeneous, for example it may comprise the same, metallic, material throughout.

The radial direction, axial direction and circumferential direction as used herein have their conventional meaning in the field of gas turbine engine components, that is relative to the gas turbine engine itself. The radial direction may be substantially aligned with a thickness direction of the fixing portion and/or with the direction in which the aerofoil extends away from the platform surface. The circumferential direction may be substantially aligned with a lateral and/or width direction of the fixing portion. The axial direction may be substantially aligned with a length direction of the fixing portion.

Where the term “substantially perpendicular” to the radial surface is used (for example in relation to the platform surface and the joggle surface), this may mean that the surface is at least a segment of a cylindrical surface or at least a segment of a frusto-conical surface, for example. Thus, “substantially perpendicular to the radial surface” includes, for example, perpendicular to a direction that has a major component in a radial direction and a minor component in an axial direction.

The joggle surface may be said to be circumferentially offset from the platform surface. The joggle surface may be circumferentially and/or radially non-overlapping with the platform surface. The joggle surface and the platform surface may have surface normals that point in substantially the same direction. Surface normal of the joggle surface and/or the platform surface may be substantially aligned with a direction that points away from the platform surface, for example with the direction in which the aerofoil extends away from the platform surface. The joggle surface may be a segment of a cylindrical or frusto-conical surface and the platform surface may be a segment of a cylindrical or frusto-conical surface that is offset from the cylindrical or frusto-conical surface of the joggle surface. The radial offset of the joggle surface from the platform surface may be in substantially the opposite direction to the direction in which the aerofoil extends away from the platform surface.

The axial extent of the joggle surface may be substantially the same as the axial extent of the platform surface. Alternatively, the axial extent of the joggle surface may be less than the axial extent of the platform surface.

The recess may be formed in the underside of the fixing portion, the underside being on the radially opposite side to the platform surface.

The recess surface may have a surface normal (or surface normals) that points in the opposite direction to that of the joggle surface.

The joggle surface may comprise a circumferentially extending locking tooth. Such a locking tooth may extend away from the joggle surface in a circumferential direction. Such a locking tooth may extend over only a part of the axial extent of the joggle surface.

The platform surface may be a gas-washed surface in use. In other words, the platform surface may form a part of the boundary of the working fluid as it passes through the engine in use.

The term annular as used in the context of an annular stator vane row includes frusto-conical.

Each stator vane in such a stator vane row is independent of the other stator vanes. Independent may mean that each stator vane is not integral with and/or attached to and/or permanently joined to any other stator vane. Independent may mean that each stator vane is free to move in at least one degree of freedom relative to the other stator vanes. For example, each stator vane may be able to independently rotate about a substantially radial direction relative to the other stator vanes.

Each stator vane in such a stator vane row may be retained in a retaining slot. Such a retaining slot may be a circumferentially extending retaining slot and/or may be an annular retaining slot. The retaining slot may be part of and/or attached to a casing, for example an engine core casing. Each stator vane may be retained by its fixing portion.

Such a retaining slot may comprise an anti-fret liner. The fixing portion of the vanes may be engaged with the anti-fret liner, for example during use. The material of an anti-fret liner may be softer than the material of the fixing portion of the vanes to ensure that it wears in preference to the fixing portion.

For arrangements in which the fixing portion has a recess the joggle surface of one stator vane in a stator vane row may be provided in the recess of a neighbouring second stator vane so as to oppose the recess surface of the neighbouring stator vane. In some arrangements, the recess surface and the joggle surface may be engaged.

According to an aspect, there is provided a gas turbine engine comprising at least one stator vane row as described and/or claimed herein. The stator vane(s) and/or stator vane row(s) may be part of a compressor, turbine, or both, for example.

According to an aspect, there is provided a method of manufacturing a stator vane as described and/or claimed herein using metal injection moulding (MIM). MIM could be used to integrally form the aerofoil and the fixing portion. However, it will be appreciated that any manufacturing method could be used to manufacture a stator vane as described and/or claimed herein, for example forging and/or machining.

The skilled person will appreciate that except where mutually exclusive, a feature described in relation to any one of the above aspects may be applied to any other aspect. Furthermore except where mutually exclusive any feature described herein may be applied to any aspect and/or combined with any other feature described herein.

### BRIEF DESCRIPTION OF THE DRAWINGS

Arrangements will now be described by way of example only, with reference to the Figures, in which:

FIG. 1 shows schematically fixing portions of two adjacent vanes of a stator vane row;

FIG. 2 shows schematically platforms of two adjacent stator vanes located in a casing slot (a) for un-joined vanes, and (b) for vanes permanently joined at neighbouring axially-extending edges of their platforms;

FIG. 3 is a sectional side view of a gas turbine engine;

FIG. 4 is a schematic side view of a stator vane in accordance with an example of the present disclosure;

FIG. 5 is a schematic perspective view of the stator vane shown in FIG. 4;

FIG. 6 is another schematic perspective view of the stator vane shown in FIG. 4;

FIG. 7 is a schematic view showing part of a stator vane row comprising the stator vanes shown schematically in FIGS. 4 to 6;

FIGS. 8A and 8B are schematic views showing vanes rotating in a retaining slot;

FIG. 9 is a schematic showing leakage flow through a stator vane row;

FIG. 10 is a schematic perspective view showing a double-ended stator vane in accordance with an example of the present disclosure;

FIG. 11 is a schematic perspective view of a stator vane in accordance with an example of the present disclosure;

FIG. 12 is a schematic view showing part of a stator vane row comprising stator vanes shown schematically in FIG. 11;

FIG. 13 is another schematic view showing part of a stator vane row comprising stator vanes shown schematically in FIG. 11;

FIG. 14 is a schematic perspective view of another stator vane in accordance with an example of the present disclosure;

FIG. 15 is another schematic view of the stator vane shown in FIG. 14;

FIG. 16 is a schematic view showing part of a stator vane row comprising stator vanes shown schematically in FIGS. 14 and 15; and

FIG. 17 is another schematic view showing part of a stator vane row comprising stator vanes shown schematically in FIGS. 14 and 15.

### DETAILED DESCRIPTION OF THE DISCLOSURE

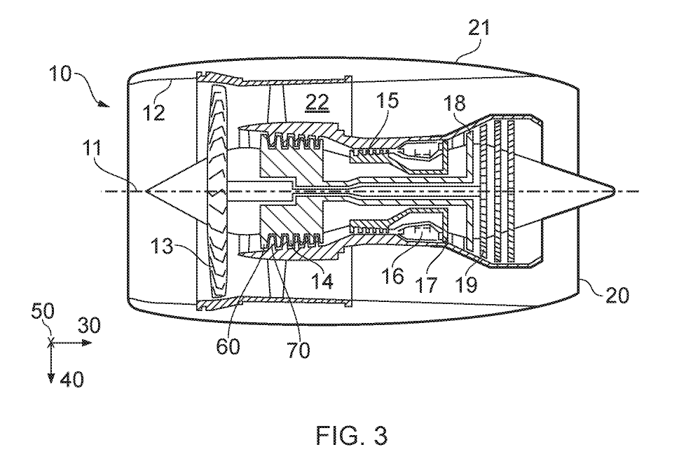

With reference to FIG. 3, a gas turbine engine is generally indicated at 10, having a principal and rotational axis 11. The engine 10 comprises, in axial flow series, an air intake 12, a propulsive fan 13, an intermediate pressure compressor 14, a high-pressure compressor 15, combustion equipment 16, a high-pressure turbine 17, an intermediate pressure turbine 18, a low-pressure turbine 19 and an exhaust nozzle 20. A nacelle 21 generally surrounds the engine 10 and defines both the intake 12 and the exhaust nozzle 20.

The gas turbine engine 10 works in the conventional manner so that air entering the intake 12 is accelerated by the fan 13 to produce two air flows: a first air flow into the intermediate pressure compressor 14 and a second air flow which passes through a bypass duct 22 to provide propulsive thrust. The intermediate pressure compressor 14 compresses the air flow directed into it before delivering that air to the high pressure compressor 15 where further compression takes place.

The compressed air exhausted from the high-pressure compressor 15 is directed into the combustion equipment 16 where it is mixed with fuel and the mixture combusted. The resultant hot combustion products then expand through, and thereby drive the high, intermediate and low-pressure turbines 17, 18, 19 before being exhausted through the nozzle 20 to provide additional propulsive thrust. The high 17, intermediate 18 and low 19 pressure turbines drive respectively the high pressure compressor 15, intermediate pressure compressor 14 and fan 13, each by suitable interconnecting shaft.

At least one of the compressors 14, 15 and the turbines 17, 18, 19 comprise stages having rotor blades in rotor blade rows (labelled 60 by way of example in relation to the intermediate pressure compressor in FIG. 3) and stator vanes in stator vane rows (labelled 70 by way of example in relation to the intermediate pressure compressor in FIG. 3).

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

The geometry of the gas turbine engine 10, and components thereof, is defined by a conventional axis system, comprising an axial direction 30 (which is aligned with the rotational axis 11), a radial direction 40, and a circumferential direction 50 (shown perpendicular to the page in the FIG. 3 view). The axial, radial and circumferential directions 30, 40, 50 are mutually perpendicular.

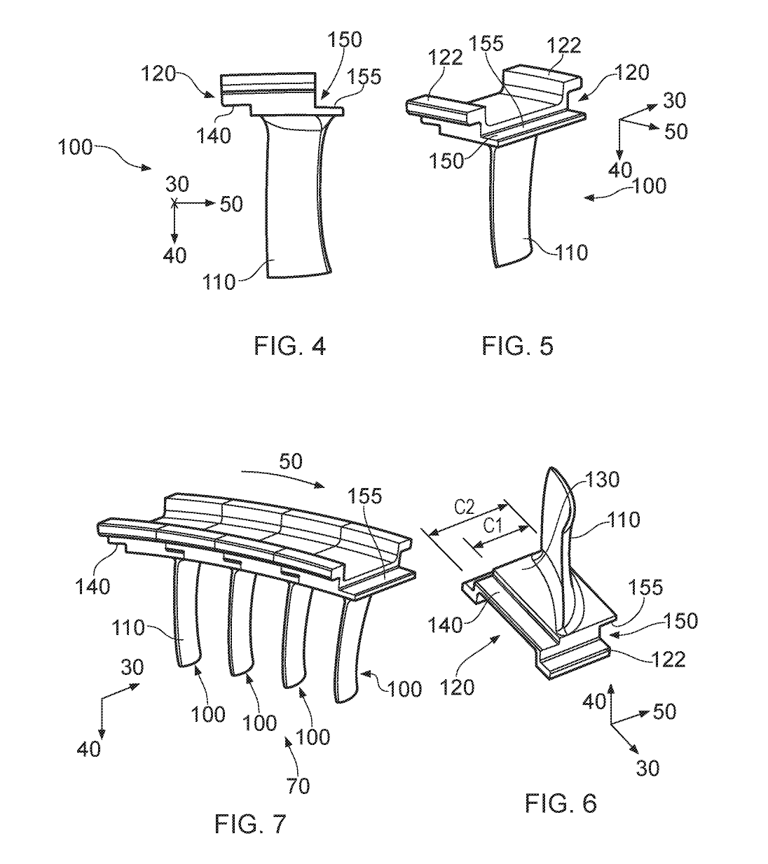

A metallic stator vane 100 in accordance with the present disclosure is shown in FIGS. 4 to 6. The stator vane 100 may be used in one or more stator vane rows 70 in a gas turbine engine 10 such as that shown in FIG. 3.

The stator vane 100 comprises an aerofoil 110 and a fixing portion 120. The fixing portion 120 is arranged to fix the stator vane 100 in a gas turbine engine 10, for example using tangs 122.

The aerofoil 110 extends from a platform surface 130. The platform surface 130 is considered to be part of the fixing portion 120. The fixing portion 120 also comprises a joggle surface 140. The joggle surface 140 may be said to be part of a joggle portion that extends circumferentially away from the platform surface 130.

The joggle surface 140 is offset from the platform surface in the radial direction 40. In the illustrated example, the fixing portion 120 is provided at the radially outer end of the stator vane 100, and so the joggle surface 140 is radially outside (i.e. at a greater radial extent) than the platform surface 130. The joggle surface 140 is offset from the platform surface 130 in the circumferential direction 50. The overall circumferential extent C2 of the vane 100, for example the overall circumferential extent C2 of the fixing portion 120, is greater than the circumferential extent C1 of the platform surface 130 alone. The combination of the circumferential offset and the radial offset of the joggle surface from the platform surface may be said to form a step in the fixing portion 120.

The vane 100 also comprises a recess 150 in the fixing portion 120, as shown in the example of FIGS. 4 to 7. The recess 150 may be said to be formed by circumferentially extending ledge that comprises a part of the platform surface 130. The recess 150 defines a recess surface 155. The recess surface 155 is substantially parallel to, and radially offset from, the platform surface 130. The recess surface 155 is substantially parallel to, and circumferentially offset from, the joggle surface 140. The geometry of the recess surface 155 and the joggle surface 140 may be substantially the same.

FIG. 7 shows a portion of a stator vane row 70 having a plurality of the stator vanes 100 assembled together. In the FIG. 7 example, the joggle surface 140 (or joggle portion) is slotted into the recess 150. The joggle surface 140 of one vane 100 may engage the recess surface of a neighbouring vane 100, as shown in FIG. 7. Each vane 100 remains independent of the other vanes 100. Even when assembled into a gas turbine engine 10, each vane 100 may be moveable in at least one degree of freedom relative to the other vanes 100. For example, each vane 100 may be rotatable about a radial direction 40 relative to the other vanes 100, within a retaining slot.

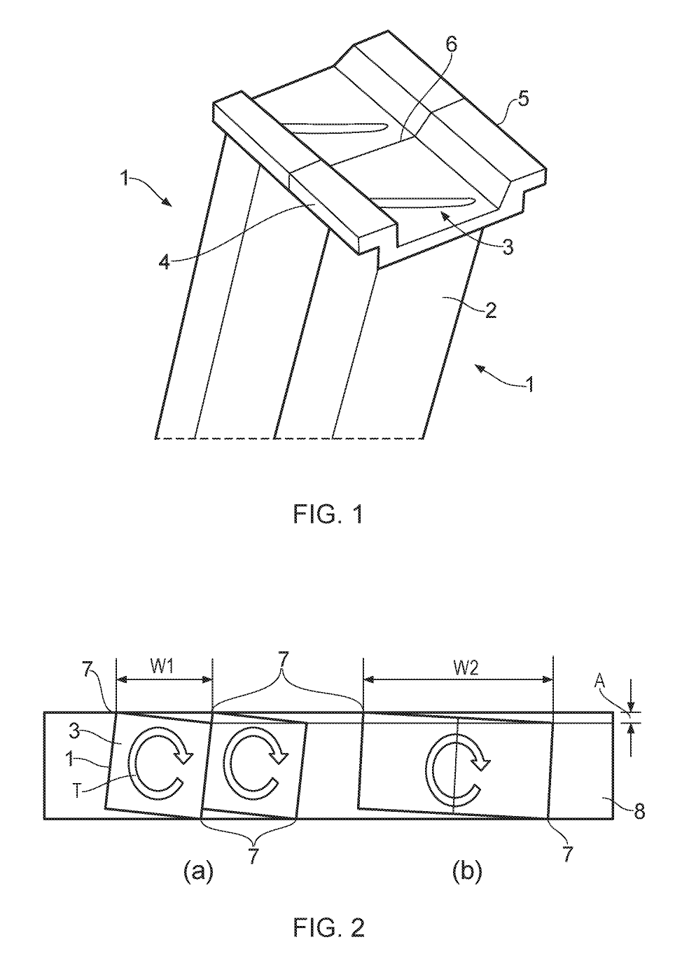

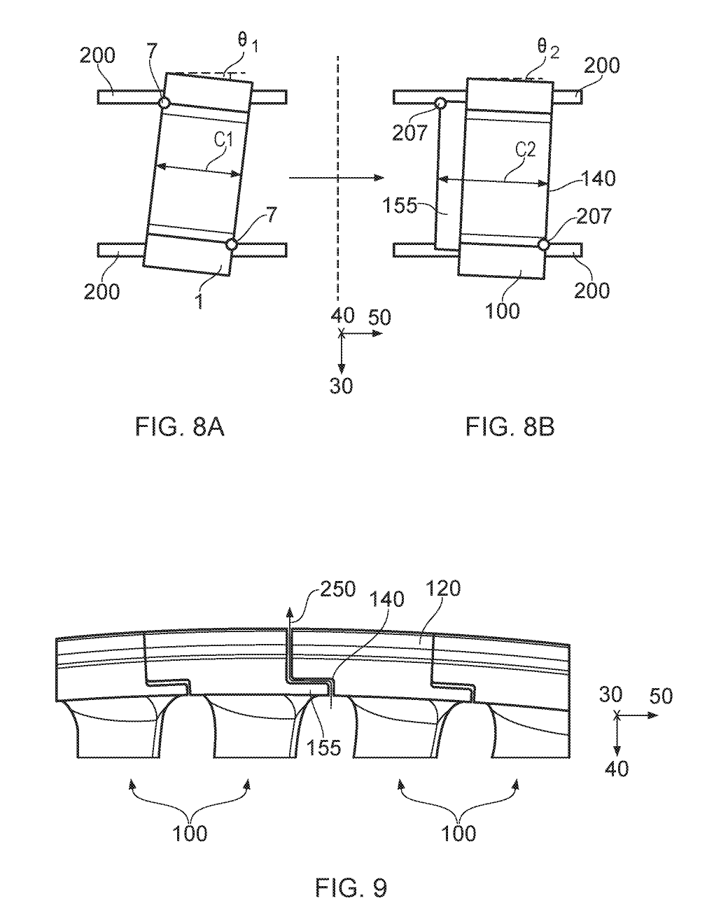

FIG. 8A shows a conventional vane 1 (such as that shown in FIG. 1, discussed above) that has rotated during use in its retaining slot 200 to a position in which the vane 1 contacts the retaining slot 200 at contact points 7. The retaining slot 200 may comprise an anti-fret lining along the contact surface. As shown in FIG. 8A, the conventional vane 1 rotates through an angle of θ1 before contacting the retaining slot 200. As mentioned above, the larger this angle, the greater the chance of damage and/or increased wear, for example due to greater forces being generated between the vane 1 and the retaining slot 200.

FIG. 8B shows a stator vane 100 in accordance with the present disclosure (such as that shown in FIGS. 4 to 7, discussed above) that has rotated during use in its retaining slot 200 to a position in which the vane 100 contacts the retaining slot 200 (which may be, for example, a T-shaped retaining slot 200) at contact points 207. Compared with the conventional vane 1 shown in FIG. 8B, the stator vane 100 rotates through a smaller angle, θ2, before contacting the retaining slot 200. This is because of the increased effective width (that is, increased circumferential extent) C2 of the stator vane 100 compared with the width C1 of the conventional vane 1. Any increase in effective width may be beneficial. Purely by way of example, the circumferential extent (or effective width) C2 of the stator vane 100 may be in the range of from 1% to 100%, for example 10% to 90%, for example 20% to 75%, for example 25% to 50%, for example on the order of 30% greater than the circumferential extent (or effective width) C1 of the stator vane 1.

This reduced rotation before contact with the cases reduces the likelihood and/or magnitude of any wear/damage caused by the contact between the vane 100 and the casing 200. Note that the size of the platform surface 130 (i.e. the surface from which the aerofoil 110 extends) may be the same for the convention vane 1 of FIG. 8A and the vane 100 in accordance with the present disclosure shown in FIG. 8B. For example, the width (or circumferential extent) of the platform surface of both vanes 1, 100 may be C1.

FIG. 9 illustrates another potential advantage of stator vanes 100 in accordance with the present disclosure. In particular, FIG. 9 illustrates a leakage path 250 for leakage flow to leak between the working fluid passing over the aerofoils 110 (and thus providing useful work, or energy output), and the region radially outside the vanes 100 (which does not provide useful work, or energy output). Such leakage flow may be problematic for all vane rows. However, as shown in FIG. 9, the leakage flow path 250 formed by arrangements in accordance with the present disclosure is tortuous. In the FIG. 9 example, the leakage flow path turns from radial 40, to circumferential 50, then back to radial 40. This may significantly reduce flow losses, and thus increase efficiency, compared to a conventional vane design, in which the leakage path is purely radial 40.

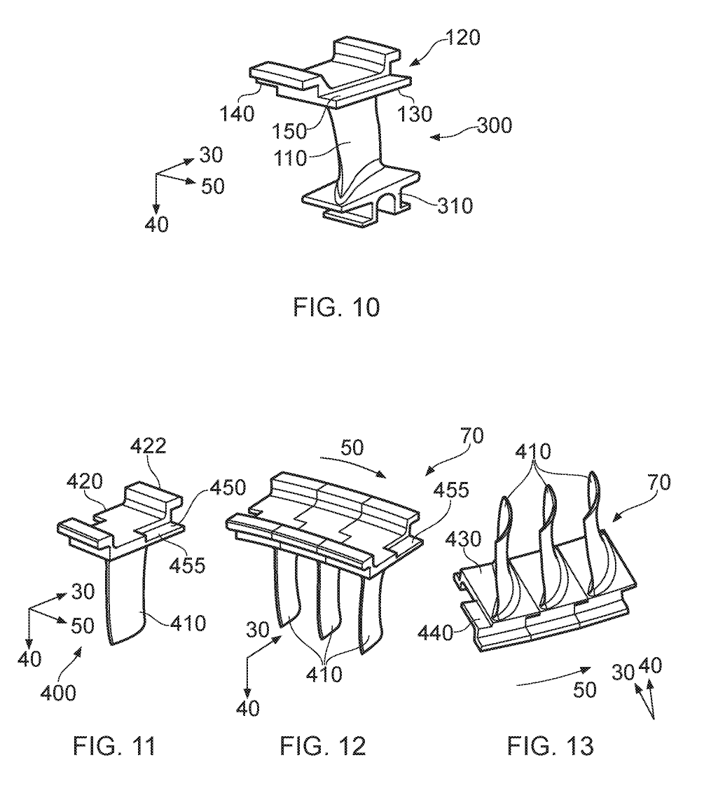

A stator vane in accordance with the present disclosure may be either a singled ended vane (as in the example described above in relation to FIGS. 4 to 7), or a double ended vane 300, as in the example shown in FIG. 10. The double ended vane 300 shown in FIG. 10 has a sealing tip 310. The sealing tip 310 may help to reduce over-tip flow during use. Any sealing tip 310 may be used. In all other aspects, the double ended vane 300 shown in FIG. 10 may be the same as the single ended vane shown in FIGS. 4 to 7, with like reference numerals representing like features. Any description provided herein in relation to a single ended vane 100 may also apply to a double ended vane 300 (for example in relation to the fixing portion 120), and so will not be repeated in relation to FIG. 10.

FIGS. 11 to 13 show a further example of a stator vane 400 in accordance with the present disclosure. The stator vane 400 shares many features with the stator vane 100 shown and described in relation to FIGS. 4 to 7. For example, the aerofoil 410, platform surface 430 and tangs 422 may be substantially the same as the aerofoil 110, platform surface 130 and tangs 122 described in relation to FIGS. 4 to 7, and so will not be described further in relation to FIGS. 11 to 13.

However, whereas the axial extent of the joggle surface 140 of the vane 100 shown in FIGS. 4 to 7 is substantially the same as the axial extent of the platform surface 130, the axial extent of the joggle surface 440 of the vane 400 shown in FIGS. 11 to 13 is less than the axial extent of the platform surface 430. Similarly, the axial extent of the recess surface 455 is less than the axial extent of the platform surface 430 in the vane 400 shown in the example of FIGS. 11 to 13. The axial extent of the recess surface 455 may be the same as the axial extent of the joggle surface 440. More generally, the geometry of the recess surface 455 may be the same as the geometry of the joggle surface 440.

FIGS. 12 and 13 show a plurality of the vanes 400 arranged together to form part of a stator vane row 70. As shown in these Figures, the configuration of the recess surface 455 and the joggle surface 440 may create an interlocking feature that may help to lock neighbouring vanes 400 together and/or may help to reduce unwanted rotation of the vanes 400 (for example about a radial direction 40. Stator vanes according to the present disclosure may, optionally, be provided with any suitable interlocking feature, of which the arrangement shown in FIGS. 11 to 13 is just one example.

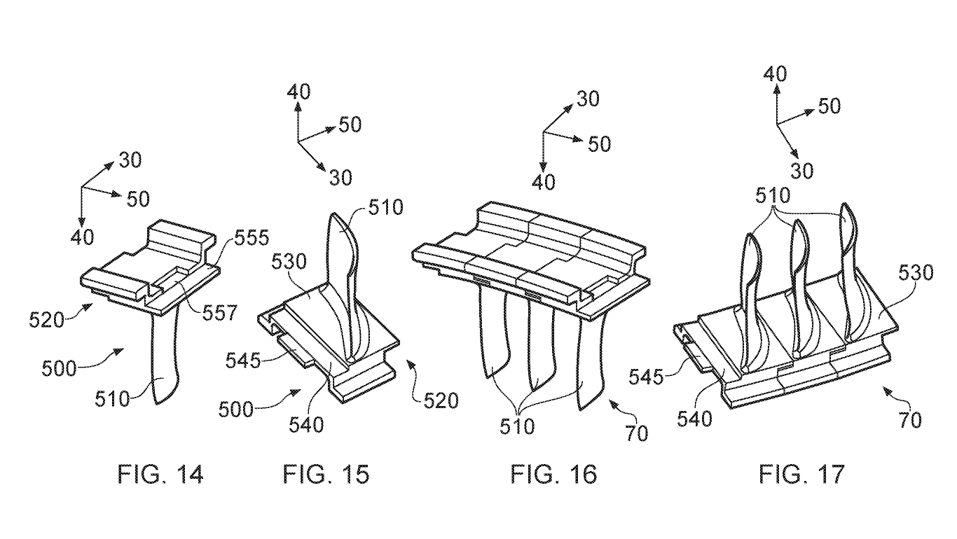

FIGS. 14 to 17 show a further example of a stator vane 500 in accordance with the present disclosure. The stator vane 500 shown in FIGS. 14 to 17 shares many corresponding features with the stator vane 100 shown in, and described in relation to, FIGS. 4 to 7. For example, the aerofoil 510, and platform surface 530 are substantially the same as the aerofoil 110 and platform surface 130 of the stator vane 100 shown in FIGS. 4 to 7, and will not be described in detail again here.

The joggle surface 540 of the stator vane 500 shown in FIGS. 14 to 17 comprises a locking tooth 545. The locking tooth 545 in this example is a circumferential extension 545 of the joggle surface 540. The circumferential extension 545 may be an extension of the rest of the joggle surface and/or may form a continuous and/or contiguous surface with the rest of the joggles surface 540. However, it will be appreciated that other geometries of locking tooth 545 may be used.

The recess surface 555 of the fixing portion 520 also has a circumferentially extending extension 557 in the FIGS. 14 to 17 example. The extension 557 of the recess surface 555 may correspond to, for example have the same geometry as, the circumferential extension 545 of the joggle surface 540. As shown in FIGS. 16 and 17, when more than one stator vane 500 are arranged together to form a stator vane row 70, the joggle surface 540 of one vane may be adjacent (and optionally engaging) the recess surface 555 of an adjacent vane 500, as with any arrangement. In the example of FIGS. 14 to 17, this means that the extension 557 of the recess surface 555 is adjacent (and optionally engaging) the extension 545 of the joggle surface 540.

Any suitable method may be used to manufacture the metallic vanes 100, 400, 500 shown and described herein. For example, each individual vane 100, 400, 500 may be manufactured using metal injection moulding (MIM).

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

We claim:

1. An annular stator vane row for an axial flow gas turbine engine stage, the annular stator vane row comprising more than two stator vanes and the gas turbine engine defining axial, radial and circumferential directions of the stator vanes, each stator vane comprising:
an aerofoil; and
a fixing portion arranged to fix the stator vane in the gas turbine engine, the fixing portion comprising a step formed by (i) a platform surface from which the aerofoil extends, and (ii) a joggle surface, wherein:
both the platform surface and the joggle surface extend substantially perpendicularly to the radial direction;
the joggle surface is radially offset from the platform surface and extends circumferentially away from the platform surface, such that the overall circumferential extent (C2) of the fixing portion is greater than the circumferential extent (C1) of the platform surface alone;
the fixing portion further comprises a recess, the recess defining a recess surface that is substantially perpendicular to the radial direction, radially offset from the platform surface and circumferentially overlapping with at least a part of the platform surface, the recess surface being geometrically the same as the joggle surface, and the joggle surface being circumferentially offset from the recess surface;
the joggle surface of one stator vane is provided in the recess of a neighbouring second stator vane so as to oppose the recess surface of the neighbouring stator vane;
each stator vane is metallic; and
each stator vane is independent of, and not permanently joined to, the other stator vanes.

2. The annular stator vane row according to claim 1, wherein the axial extent of the joggle surface is substantially the same as the axial extent of the platform surface.

3. The annular stator vane row according to claim 1, wherein the axial extent of the joggle surface is less than the axial extent of the platform surface.

4. The annular stator vane row according to claim 1, wherein the recess surface has a surface normal that points in the opposite direction to that of the joggle surface.

5. The annular stator vane row according to claim 1, wherein the joggle surface comprises a circumferentially extending locking tooth that extends over only a part of the axial extent of the joggle surface.

6. The annular stator vane row according to claim 1, wherein, in use, the platform surface is a gas-washed surface.

7. The annular stator vane row according to claim 1, wherein each stator vane is retained in a circumferentially extending retaining slot by its fixing portion.

8. The annular stator vane row according to claim 7, wherein the retaining slot comprises an anti-fret liner with which the fixing portion of the vanes are engaged.

9. A gas turbine engine comprising at least one stator vane row according to claim 1.

10. A method of manufacturing an annular stator vane row according to claim 1, comprising manufacturing each of the stator vanes using metal injection moulding.
